(19) United States
(12) Patent Application Publication
(10) Pub. No.: US 2018/0170118 A1
(43) Pub. Date: Jun. 21, 2018

(54) TIRE WITH MAGNETIC TREAD DETECTION

(71) Applicant: Bridgestone Americas Tire Operations, LLC, Nashville, TN (US)

(72) Inventors: Terence E. Wei, Copley, OH (US); Sheel P. Agarwal, Solon, OH (US)

(21) Appl. No.: 15/841,818

(22) Filed: Dec. 14, 2017

Related U.S. Application Data
(60) Provisional application No. 62/434,777, filed on Dec. 15, 2016.

(51) Int. Cl. B60C 11/24; B60C 11/03; B60C 23/04

(52) U.S. Cl. CPC B60C 11/24; B60C 2019/005; B60C 23/0493; B60C 11/03

(57) ABSTRACT

A tire includes at least one annular structure configured to interface with a wheel. The tire also includes a circumferential tread disposed in a crown region of the tire and a package having magnetic particles and an erodible medium, disposed within the circumferential tread. The magnetic particles are distributed along a gradient of increasing concentration.

### FIELD OF INVENTION

This disclosure relates to structures and methods used to notify a driver, passenger, or other observer that a tire tread has worn to a predetermined limit. More particularly, the disclosure relates to tires including at least one belt having magnetic properties, tires including at least one package having magnetic particles and an erodible medium, and methods for detecting tread wear that pertain to tires including at least one belt having magnetic properties or tires including at least one package having magnetic particles and an erodible medium.

### BACKGROUND

Structures and methods for gauging tread wear are known. For example, tread wear indicators provide a visual indication that a tire tread has worn to a predetermined limit, and the “penny test” (i.e., inserting a penny into a groove to measure the height of a tread element relative to a feature of the coin) and direct measurements have been used to ascertain tread depth. These structures and tests require physical observation (when the tire is stationary) in order to determine the tread depth.

### SUMMARY OF THE INVENTION

In one embodiment, a tire includes at least one annular structure configured to interface with a wheel. The tire also includes a circumferential tread disposed in a crown region of the tire and a package having magnetic particles and an erodible medium, disposed within the circumferential tread. The magnetic particles are distributed along a gradient of increasing concentration.

In another embodiment, a tire includes a first annular bead, a second annular bead, and a body ply extending between the first annular bead and the second annular bead. The tire further includes an annular belt package. The annular belt package has a first annular belt, disposed radially upward of the body ply and extending axially across a portion of the body ply, and a second annular belt, disposed radially upward of the first annular belt and extending axially across a portion of the body ply. The tire also includes a circumferential tread disposed radially upward of the first and second annular belts and extending axially across a portion of the body ply. The tire also has a first sidewall extending between the first annular bead and a first shoulder, and a second sidewall extending between the second annular bead and a second shoulder. The first shoulder and the second shoulder are each associated with the circumferential tread. One of the first annular belt and the second annular belt produces a magnetic field of 4.0-16.0 mT when measured from an outer surface of the circumferential tread.

In still another embodiment, a method for detecting tread wear includes providing a tire with a magnetic component and providing a sensor within a measurable distance from the tire. The method also includes sensing a magnetic field generated by the magnetic component, and inferring a tread depth according to the sensed magnetic field.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a peel-away cross-sectional perspective view of an embodiment of a pneumatic tire including a belt having magnetic properties;

FIG. 2a is a peel-away cross-sectional perspective view of an embodiment of a pneumatic tire including a plurality of packages comprising magnetic particles and an erodible medium;

FIG. 2b is a front cross-sectional view of the tire including at least one package comprising magnetic particles and an erodible medium, as shown in FIG. 2a;

FIG. 2c is a front cross-sectional view of an alternative embodiment of the tire including at least one package comprising magnetic particles and an erodible medium, as shown in FIG. 2b;

FIG. 3 is a perspective view of a package comprising magnetic particles and an erodible medium;

FIG. 4a is a side cross-sectional view of one embodiment of a non-pneumatic tire including a belt having magnetic properties;

FIG. 4b is a side cross-sectional view of an alternative embodiment of a non-pneumatic tire including at least one package comprising magnetic particles and an erodible medium;

FIG. 5 is a flowchart describing one embodiment of a method for detecting tread wear in a tire including at least one belt having magnetic properties; and

FIG. 6 is a flowchart describing an alternative embodiment of a method for detecting tread wear in a tire including at least one package comprising magnetic particles and an erodible medium.

### DETAILED DESCRIPTION

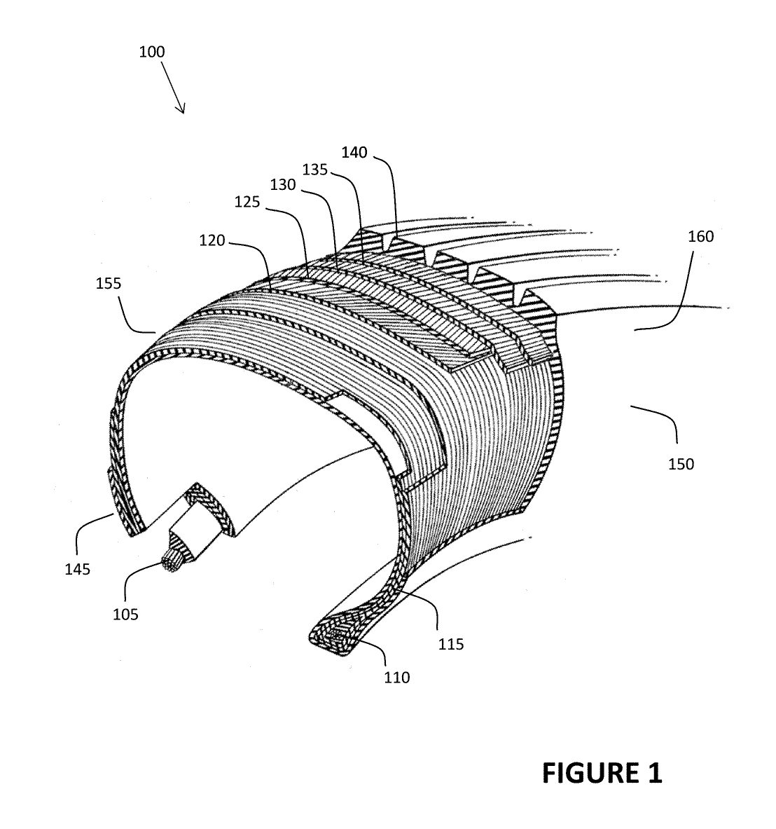

FIG. 1 is a peel-away cross-sectional perspective view of an embodiment of a pneumatic tire 100 including a belt having magnetic properties.

As shown, tire 100 includes a first annular bead 105 and a second annular bead 110. The annular beads, in part, secure the tire to a wheel. In an alternative embodiment (not shown), the tire comprises four or more beads.

Tire 100 further includes a body ply 115 extending between first annular bead 105 and second annular bead 110. Body ply 115 forms an annulus and imparts shape to the tire. As one of ordinary skill in the art will understand, body ply 115 may contain reinforcing cords (not labeled) or fabric (not shown). In alternative embodiments (not shown), various turn-up and turn-down configurations, or multiple body plies, are used.

Tire 100 further includes an annular belt package which comprises a first annular belt 120 and a second annular belt 125. First annular belt 120 is disposed radially upward of body ply 115 and extends axially across a portion of body ply 115. Second annular belt 125 is disposed radially upward of first annular belt 120 and extends axially across a portion of body ply 115. As one of ordinary skill in the art will understand, the annular belts may contain steel cords and reinforcing cords (both not shown). In an alternative embodiment (not shown), the belt package includes a third annular belt.

In tire 100, as circumferential tread 140 (discussed further below) wears due to use, at least one of the annular belts will become closer to the tread surface. As the belt (or belts) moves relatively closer to the tread surface, the magnetic field produced by the belt will appear stronger to a magnetometer placed at the tread surface, thus indicating that the tire is worn. In an alternative embodiment, the tire is driven over a surface that contains a magnetometer. In another alternative embodiment, the magnetometer is mounted on a car (such as in a wheel well).

Although not shown in FIG. 1, at least one of the annular belts in the annular belt package produces a magnetic field. In one embodiment, a single annular belt having magnetic properties produces a static magnetic field of 4.0-16.0 mT when measured from the tread surface. In an alternative embodiment, a single annular belt having magnetic properties produces a static magnetic field of 4.0-16.0 mT when measured from the tread surface. In another embodiment, two or more annular belts produce a static magnetic field.

As one of ordinary skill in the art will understand, the annular belts produce a static magnetic field due, in part, to their ferromagnetic properties. Exemplary suitable materials include cords made of carbon steel or alloy steel. In one embodiment, all of the metallic cords in an annular belt are magnetic. In an alternative embodiment, a fraction of the metallic cords in an annular belt are magnetic.

With continued reference to FIG. 1, tire 100 further comprises a first cap ply 130 and a second cap ply 135. First cap ply 130 is disposed radially above first annular belt 120 and second annular belt 125, and extends axially across a portion of body ply 115. Second cap ply 135 is disposed radially above first cap ply 130, and extends axially across a portion of body ply 115. In an alternative embodiment (not shown), a sealing gel layer is provided in the cap ply region.

Tire 100 further comprises a circumferential tread 140. Circumferential tread 140 is disposed radially upward of second cap ply 135 (and the belt package) and extends axially across a portion of body ply 115. The width of the circumferential tread 135 is known as the tread width. As depicted, four circumferential grooves divide circumferential tread 140 into five ribs. As one of ordinary skill in the art will understand, a circumferential tread may contain additional elements such as, without limitation, axial grooves, sacrificial ribs, sipes, stone ejectors, and tie bars. As one of ordinary skill in the art will also understand, the circumferential tread is affixed to the tire (e.g., by vulcanization) when the tire is new. In an alternative embodiment (not shown), the circumferential tread is affixed as a retread.

Tire 100 further comprises a first sidewall 145 and a second sidewall 150. First sidewall 145 extends between the first annular bead 105 and a first shoulder 155, which is proximately associated with an edge of circumferential tread 140. Second sidewall 150 extends between the second annular bead 110 and a second shoulder 160, which is proximately associated with an opposite edge of circumferential tread 140. In alternative embodiments (not shown), the sidewall includes one or more sidewall protector(s), electronic device(s), and/or cooling fin(s). In a particular alternative embodiment, the tire further comprises an RFID chip configured to record data associated with a tread-depth measurement.

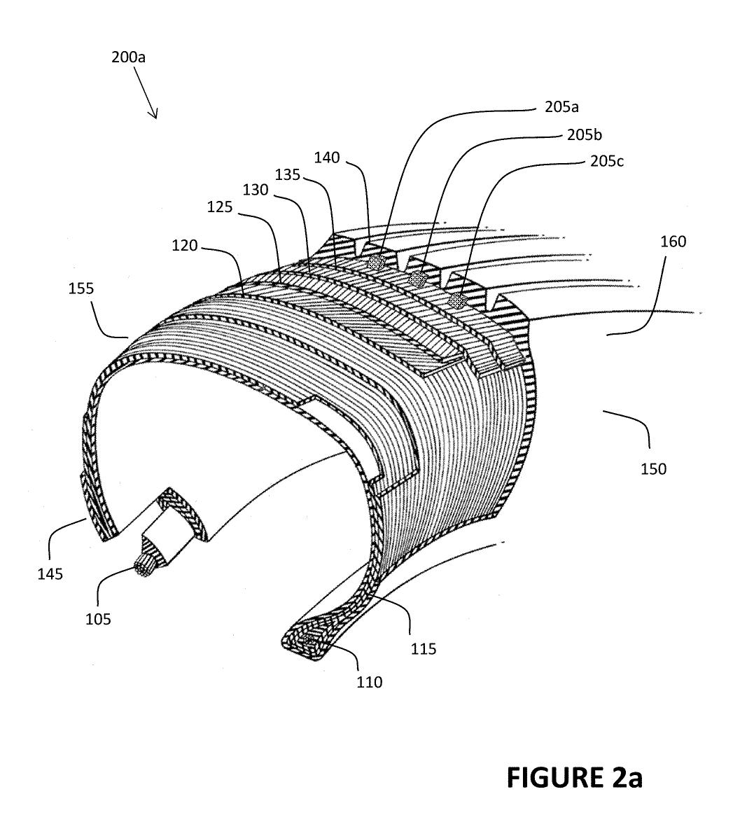

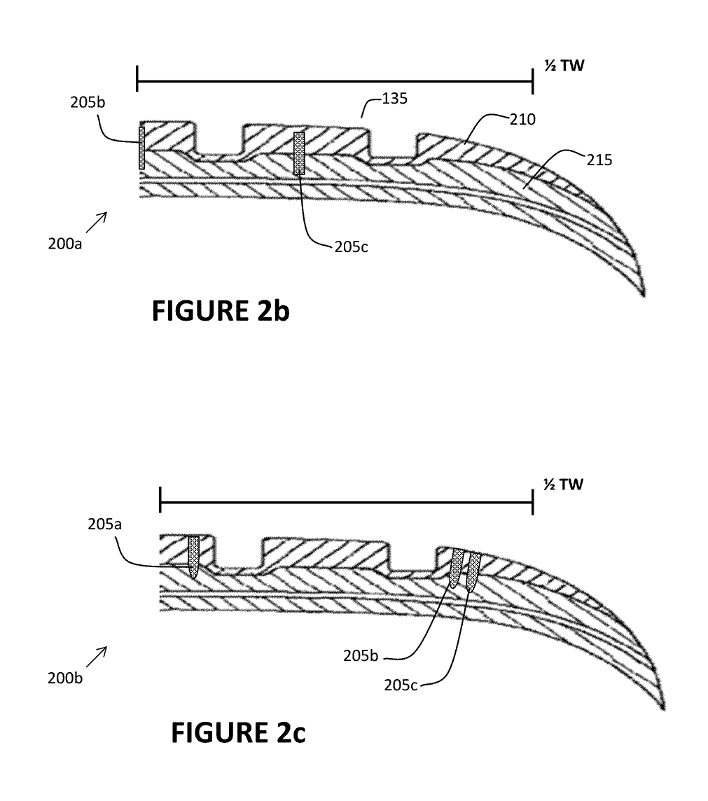

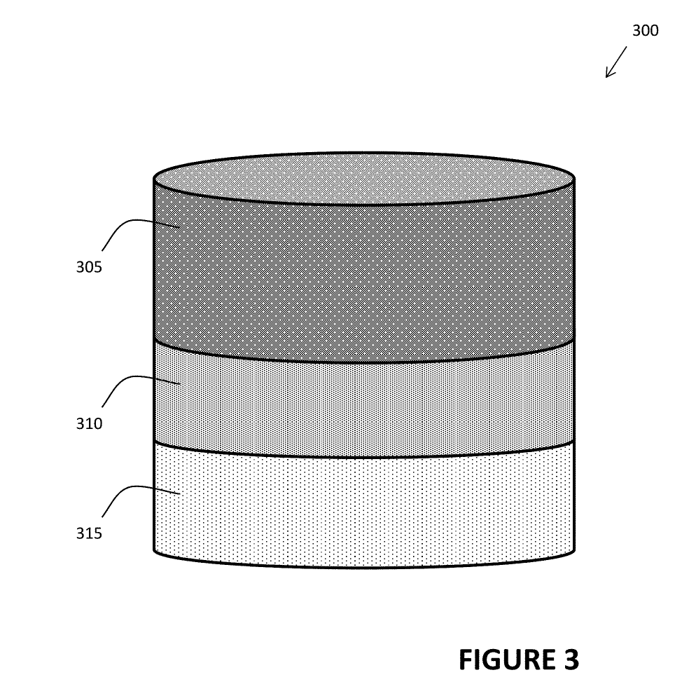

FIG. 2a is a peel-away cross-sectional perspective view of an embodiment of a pneumatic tire 200a including at least one package comprising magnetic particles and an erodible medium. The FIG. 2a embodiment is substantially similar to the FIG. 1 embodiment, except for the differences discussed below. Like numerals are used to indicate like components.

Tire 200a, in contrast to tire 100, includes an annular belt package that produces a static magnetic field less than 600 μT. In one particular embodiment, the annular belt package produces a static magnetic field less than 400 μT.

In addition, tire 200a further includes packages 205a, 205b, and 205c, which comprise magnetic particles and an erodible medium. As shown in FIG. 2a, packages 205a, 205b, and 205c are disposed radially above second cap ply 135, on a common axial line. In an alternative embodiment (not shown), the packages are distributed about the tire circumference. In another alternative embodiment, only one package is disposed within the circumferential tread.

Although not shown, the packages contain magnetic particles which are distributed along a gradient of increasing concentration. In one embodiment, the higher concentration portion of the package is disposed closer to the tread surface. In an alternative embodiment, a lower concentration portion of the package is disposed closer to the tread surface.

FIG. 2b is a front cross-sectional view of tire 200a as shown in FIG. 2a. In this embodiment, packages 205b and 205c are disposed within circumferential tread 140. In FIG. 2b, circumferential tread 140 further includes a tread cap 210 and a tread base 215. Tread base 215 is disposed radially upward of the second cap ply and the belt package (both not shown) and extends axially across a portion of body ply (also not shown). Tread cap 210 is disposed radially upward of tread base 215 and extends axially across a portion of body ply. Tread cap 210 may be formulated to possess particular performance attributes that are desirable when the tire is new. As one of ordinary skill in the art will understand, the tread cap and tread base are normally made of different compounds. In alternative embodiment, the tread is made of one compound.

As shown in FIG. 2b, packages 205b and 205c are disposed in the tread base 215 and extend into tread cap 210. In an alternative embodiment (not shown), at least one package extends to the tread surface when the tire is new. In another alternative embodiment, at least one package extends across 50-100% of a rib width.

FIG. 2c is a front cross-sectional view of alternative embodiment of a tire 200c including at least one package comprising magnetic particles and an erodible medium as shown in FIG. 2b. The FIG. 2c embodiment is substantially the same as the FIG. 2b embodiment, except for the differences discussed below. Like reference numerals are used to indicate like components.

In this embodiment, packages 205b and 205c are disposed in the outer third of tire 200b. In alternative embodiments, additional packages are disposed at different axial locations across the tire. As one of ordinary skill will understand, the packages may be used in a variety of tire constructions.

FIG. 3 is a perspective view of an embodiment of a package 300 comprising magnetic particles and an erodible medium. The package 300 is substantially similar to the packages shown in FIGS. 2a-2c, except for the differences discussed below.

As shown in FIG. 3, package 300 contains a first tier 305, a second tier 310, and a third tier 315. First tier 305 includes magnetic particles that produce a magnetic field of 12-16 mT, second tier 310 includes magnetic particles that produce a magnetic field of 8-12 mT, and a third tier 315 includes magnetic particles that produce a magnetic field of 4-8 mT. In an alternative embodiment (not shown), the first tier includes magnetic particles at a concentration of 5-6 g/cm³, the second tier includes magnetic particles at a concentration of 4-5 g/cm³, and the third tier includes magnetic particles at a concentration of 3-4 g/cm³.

Although not shown in FIG. 3, the magnetic particles may be made of the group consisting of SrFe₁₂O₁₉, amorphous Fe73.5Cu₁Nb₃Si_{1.35}B₉ or Sm₂Fe₁₄B and La₂Fe₁₄B. The magnetic particles may have a density between 3.5 and 5.1 g/cm³. In another aspect of this embodiment, the magnetic particles have a diameter between 0.5 and 1.0 μm.

In tire embodiments that use packages containing magnetic particles, as the tread wears due to use, magnetic particles will erode from the tire, and the strength of the magnetic field emitted from the package will decrease. In one embodiment, the magnetic field is monitored with a magnetometer, which is placed against the surface of the tread. In an alternative embodiment, the tire is driven over a surface that contains a magnetometer. In another alternative embodiment, the magnetometer is mounted on a car (such as in a wheel well).

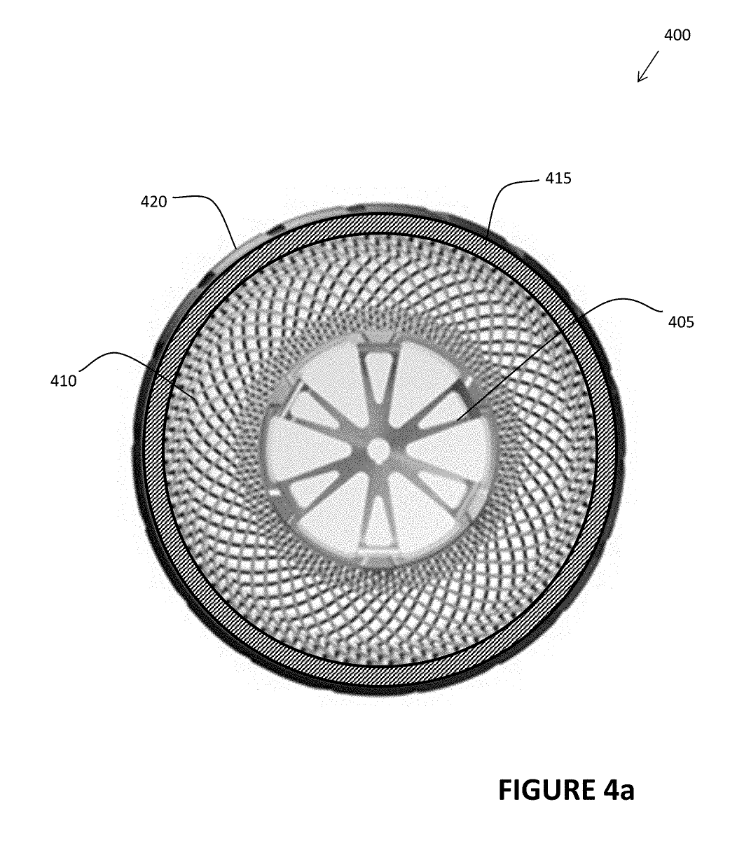

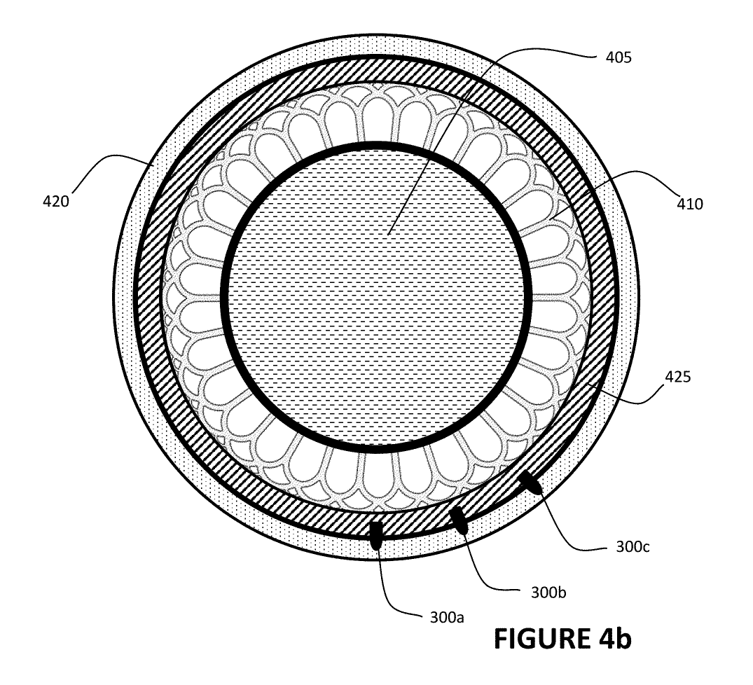

FIG. 4a is a side cross-sectional view of a tire 400 including a magnetic belt 415. As shown, tire 400 is a non-pneumatic tire, with wheel 405, spokes 410, and tread 420 shown for context. Magnetic belt 415 is disposed radially between spokes 410 and tread 420. As tread 420 wears due to use, magnetic belt 415 will become closer to the tread surface. As the magnetic belt is closer to the tread surface, the magnetic field will appear stronger to a magnetometer placed at the tread surface, thus indicating that the tire is worn.

FIG. 4b is a side cross-sectional view of an alternative embodiment of a tire including a band 425. The FIG. 4b embodiment is substantially the same as the FIG. 4a embodiment, except for the differences discussed below. Like reference numerals are used to indicate like components.

As shown in FIG. 4b, packages 300a, 300b, and 300c extend from band 425 into tread 420. In the illustrated embodiment, the packages are disposed within one quadrant of the tire. In one alternative embodiment (not shown), the packages extend from the tread surface into the tread. In another alternative embodiment, the packages are distributed in disparate quadrants.

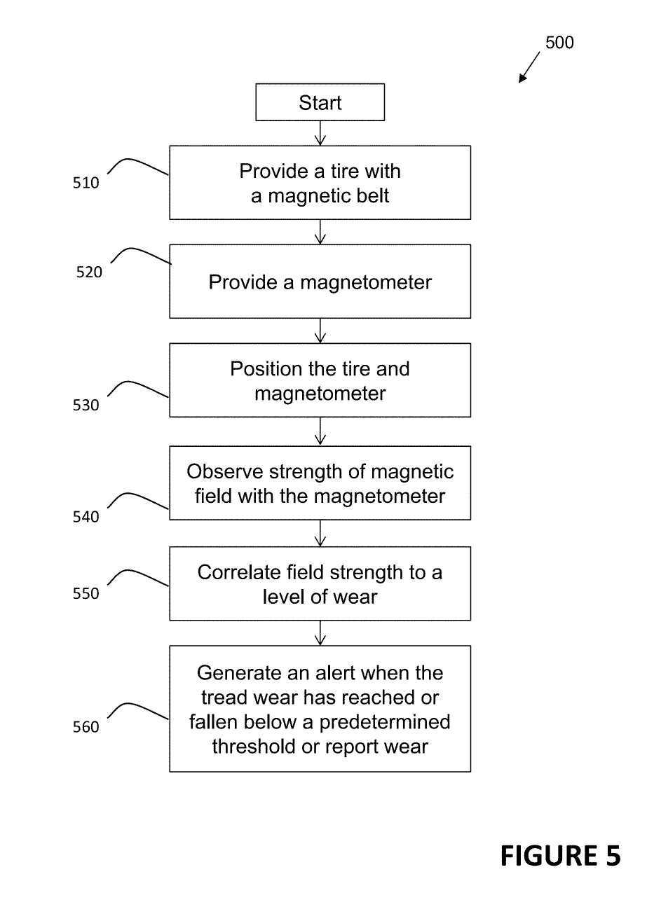

FIG. 5 is a flowchart describing one embodiment of a method 500 of detecting tread wear in a tire including at least one belt having magnetic properties.

As depicted in FIG. 5, method 500 starts with providing a tire with a magnetic belt 510 and separately providing a magnetometer 520. Providing step 510 and providing step 520 may be performed concurrently or independently. In providing step 510, a tire is mounted on a wheel, a vehicle having a mounted tire is provided, or a tire mounted on a wheel is presented for measurement. In providing step 520, a magnetometer is presented (e.g., as a handheld sensor) to take a measurement, a magnetometer is mounted on a vehicle, or a magnetometer is provided on a floor surface.

In one embodiment, the magnetometer has a sensitivity of at least 0.01 mT. In another embodiment, the magnetometer has a sensitivity of at least 0.001 mT.

In connection with providing step 510 and providing step 520, a user or machine positions the tire and magnetometer 530 within proximity of each other. In one embodiment, the tire is positioned by driving it over a surface that contains the magnetometer. In another embodiment, the magnetometer is positioned by placing it in contact with the tire. In a different embodiment, the magnetometer is mounted on a car (such as in a wheel well).

Once providing step 510, providing step 520, and positioning step 530 are performed, the strength of the magnetic field is measured 540 using the magnetometer. In one embodiment, the measurement is displayed on the magnetometer. In another embodiment, the measurement is transmitted to a digital device. In yet another embodiment, the measurement is recorded on an RFID chip.

After measuring step 540 is completed, the measurement is correlated 550 to a level of wear. In correlating step 550, the strength of the magnetic field is used to estimate the tread depth. Table 1, below, is an exemplary lookup table used to calculate tread wear:

| Magnetic Field (mT) | Tread Depth (mm) |
|---|---|
| 4.0 | 9 |
| 4.5 | 8 |
| 5.5 | 6 |
| 6.5 | 5 |
| 8.0 | 3 |

In an alternative embodiment of correlating step 550, the measurement from the magnetometer is compared to an initial measured value corresponding to an initial (unworn) state of the tread. The measurement is then processed along with the initial measured value in an algorithm, which is used to calculate the worn tread depth.

After correlating step 550 is completed, the correlation may be used in generating 560 an alert when the tread wear has reached a predetermined threshold. The generating step 560 may be performed concurrently or independently of positioning step 530, measuring step 540, and correlating step 550.

In generating step 560, the strength of the magnetic field is compared against a predetermined threshold. If the strength of the magnetic field has reached the threshold, then an alert relating to the worn state is generated. In another embodiment, a wear alert (or report) is generated at regular intervals for maintenance purposes. The alerts (or reports) can include a predication of how much longer the tread can be used. In a different embodiment, a wear alert (or report) is generated at regular intervals for quality assurance and performance tracking purposes.

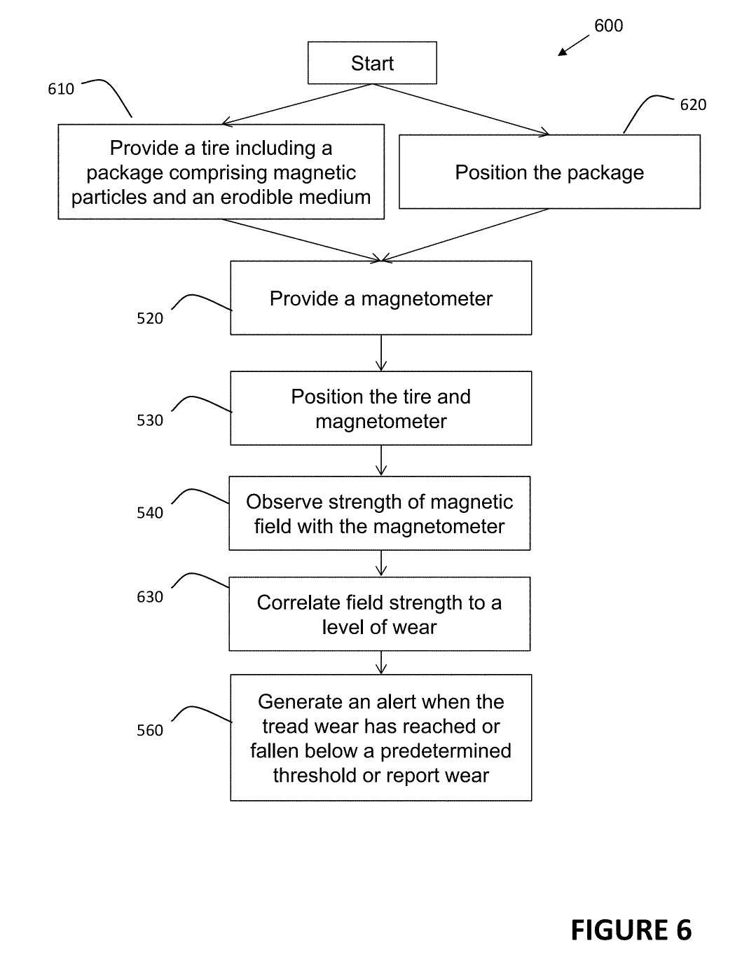

FIG. 6 is a flowchart describing one embodiment of a method for detecting tread wear in a tire including at least one package comprising magnetic particles and an erodible medium. The FIG. 6 embodiment is substantially similar to the FIG. 5 embodiment, except for the differences discussed below.

As depicted in FIG. 6, method 600 starts with providing 610 a tire including at least one package comprising magnetic particles and an erodible medium. In providing step 610, at least one package comprising magnetic particles and an erodible medium is provided within a tire tread. In one embodiment, the package is provided by being placed within, or forcibly propelled into, a slot in the tread. The slot may be created using, without limitation, a needle, cannula, blade, pin, nail, drill, or tire mold. The diameter of the slot is between 80 and 120% of the diameter of the package. Alternatively, a slot may be created using 3D printing or subtractive manufacturing. As one of ordinary skill in the art will understand, adhesives or liquid rubber may be used to fix the package within the slot.

In an alternative embodiment, the package is provided by being placed within, or forcibly propelled into, a hole. A hole may be created using, without limitation, a needle, cannula, blade, pin, nail, drill, tire mold, 3D printing, or subtractive manufacturing. In alternative embodiments, the diameter of the hole is between 120 and 200% of the diameter of the package. As one of ordinary skill in the art will understand, adhesives or liquid rubber may be used in conjunction with providing the package within the hole.

Method 600 then continues with positioning 620 the at least one package comprising magnetic particles and an erodible medium. In positioning step 620, it is determined where the package(s) is/are disposed about the tread. The packages may be disposed according to the descriptions provided with regard to FIGS. 1-4 above.

After positioning step 620 is completed, method 600 continues with providing step 520, positioning step 520, and measuring step 540.

Method 600 then continues with correlating step 630. In correlating step 630, the measurement is correlated 630 to a level of wear. In this step, the strength of the magnetic field is used to estimate the tread depth. Table 2, below, is an exemplary lookup table used to calculate tread wear when magnetic particles are utilized:

| Magnetic Field (mT) | Tread Depth (mm) |
|---|---|
| 8.0 | 9 |
| 6.5 | 8 |
| 5.5 | 6 |
| 4.5 | 5 |
| 4.0 | 3 |

Method 600 then concludes with generating step 560.

As one of ordinary skill in the art would understand, the tire embodiments described in this disclosure may be configured for use on a vehicle selected from the group consisting of motorcycles, tractors, agricultural vehicles, lawnmowers, golf carts, scooters, airplanes, military vehicles, passenger vehicles, hybrid vehicles, high-performance vehicles, sport-utility vehicles, light trucks, heavy trucks, heavy-duty vehicles, and buses.

One of ordinary skill in the art would also understand that the embodiments described in this disclosure may be utilized with a variety of tread patterns, including, without limitation, symmetrical, asymmetrical, directional, studded, and stud-less tread patterns.

One of ordinary skill in the art would also understand that the embodiments described in this disclosure may be utilized, without limitation, in high-performance, winter, all-season, touring, non-pneumatic, and retread tire applications.

One of ordinary skill in the art would also understand that the embodiments described in this disclosure may be utilized in large tires. Examples of large tires include, but are not limited to, agricultural tires, mining tires, forestry tires, skid steer tires, construction tires, monster-truck tires, and other heavy-duty vehicle tires.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

1. A tire comprising:
at least one annular structure configured to interface with a wheel;
a circumferential tread disposed in a crown region of the tire; and
a package having magnetic particles and an erodible medium, disposed within the circumferential tread, wherein the magnetic particles are distributed along a gradient of increasing concentration.

2. The tire of claim 1, wherein the package further comprises a first tier including magnetic particles which produces a magnetic field of 12-16 mT, a second tier including magnetic particles which produces a magnetic field of 8-12 mT, and a third tier including magnetic particles which produces a magnetic field of 4-8 mT.

3. The tire of claim 1, wherein the package further comprises a first tier including magnetic particles having a concentration of 5-6 g/cm³, a second tier including magnetic particles having a concentration of 4-5 g/cm³, and a third tier including magnetic particles having a concentration of 3-4 g/cm³.

4. The tire of claim 1, wherein the magnetic particles are SrFe₁₂O₁₉, amorphous Fe_{73.5}Cu₁Nb₃Si_{13.5}B₉ or Sm₂Fe₁₄B or La₂Fe₁₄B.

5. The tire of claim 4, wherein the magnetic particles have a density between 3.5 and 5.1 g/cm³.

6. The tire of claim 4, wherein the magnetic particles have a diameter between 0.5 and 1.0 μm.

7. The tire of claim 1, wherein the tire further comprises a plurality of packages distributed about a circumference of the tire.

8. The tire of claim 1, wherein the circumferential tread is a retread.

9. A tire comprising:
a first annular bead and a second annular bead;
a body ply extending between the first annular bead and the second annular bead;
an annular belt package, including a first annular belt, disposed radially upward of the body ply and extending axially across a portion of the body ply, and a second annular belt, disposed radially upward of the first annular belt and extending axially across a portion of the body ply;
a circumferential tread disposed radially upward of the first and second annular belts and extending axially across a portion of the body ply; and
a first sidewall extending between the first annular bead and a first shoulder, the first shoulder being associated with the circumferential tread, and a second sidewall extending between the second annular bead and a second shoulder, the second shoulder being associated with the circumferential tread,
wherein one of the first annular belt and the second annular belt produces a magnetic field of 4.0-16.0 mT when measured from an outer surface of the circumferential tread.

10. The tire of claim 9, wherein the second annular belt also produces the magnetic field of 4.0-16.0 mT when measured from the outer surface of the circumferential tread.

11. The tire of claim 9, wherein one of the first annular belt and the second annular belt includes metallic cords, and wherein at least some of the metallic cords are magnetic.

12. The tire of claim 9, wherein one of the first annular belt and the second annular belt includes cords made of a material selected from the group consisting of: carbon steel and alloy steel.

13. The tire of claim 9, further comprising a third annular belt which produces a magnetic field of 4.0-16.0 mT when measured from the outer surface of the circumferential tread.

14. The tire of claim 9, further comprising an RFID chip configured to record data associated with a tread-depth measurement.

15. The tire of claim 9, wherein the tire is a heavy duty, off-the-road, non-pneumatic, or truck-and-bus radial tire.

16. A method for detecting tread wear, comprising:
providing a tire with a magnetic component;
providing a sensor within a measurable distance from the tire;
sensing a magnetic field generated by the magnetic component; and
inferring a tread depth according to the sensed magnetic field.

17. The method of claim 16, further comprising calculating a wear rate based upon at least two tread depth inferences.

18. The method of claim 16, further comprising calculating a percentage of tread wear.

19. The method of claim 16, further comprising generating an alert when the tread depth reaches a predetermined value.

20. The method of claim 16, further comprising saving data associated with a measurement to an RFID disposed on the tire.
